(19) United States
(12) Patent Application Publication
(10) Pub. No.: US 2014/0321374 A1
(43) Pub. Date: Oct. 30, 2014

(54) RADIO RESOURCE ALLOCATION APPARATUS AND METHOD USING INTERFERENCE INDICATOR IN FEMTO CELL NETWORK

(71) Applicant: ELECTRONICS AND TELECOMMUNICATIONS RESEARCH INSTITUTE, Daejeon-city (KR)

(72) Inventors: Jun-Sik KIM, Seoul (KR); Sook-Jin LEE, Daejeon (KR)

(73) Assignee: ELECTRONICS AND TELECOMMUNICATIONS RESEARCH INSTITUTE, Daejeon-city (KR)

(21) Appl. No.: 14/259,776

(22) Filed: Apr. 23, 2014

(30) Foreign Application Priority Data
Apr. 24, 2013 (KR) 10-2013-0045456

(51) Int. Cl. H04L 5/00

(52) U.S. Cl. CPC H04L 5/0073; H04L 5/0032; H04L 5/0057
USPC 370/329

(57) ABSTRACT

A radio resource allocation apparatus and method using an interference indicator in a femto-cell network are disclosed. The radio resource allocation apparatus using an interference indicator in a femto-cell network includes: an interference indicator obtaining unit obtaining any one or more of interference indicators including load information of a base station in the femto-cell network, a change amount of reference signal received power (RSRP) to reference signal received quality (RSRQ), and a channel quality indicator (CQI); a priority determining unit providing different weights to each of the interference indicators and determining an allocation priority of radio resources using the interference indicators to which the weights are provided; and a radio resource allocating unit allocating the radio resources to the base station in any one of a dedicated carrier mode, a partially shared carrier mode, and a shared carrier mode using the allocation priority.

### CROSS REFERENCE TO RELATED APPLICATION

This application claims the benefit of Korean Patent Application No. 10-2013-0045456, filed on Apr. 24, 2013, which is hereby incorporated by reference in its entirety into this application.

### BACKGROUND OF THE INVENTION

1. Technical Field

The present invention relates to a radio resource allocation apparatus and method using an interference indicator in a femto-cell network, and more particularly, to a radio resource allocation apparatus and method using an interference indicator in a femto-cell network capable of allocating radio resources in carrier modes differently determined depending on interference indicators of base stations.

2. Description of the Related Art

Recently, the use of a femto-cell base station in wireless communication of a terminal has increased. The femto-cell base station has a small connection range, but may be installed at a distance close to the terminal and has service quality more excellent than a macro-cell base station due to the distance close to the terminal. Therefore, the femto-cell base station has been widely used in order to operate and provide public services such as public safety, air line and harbor, traffic, railroad, and the like.

Generally, in the case in which a subscriber's user terminal enters the femto-cell base station, a handover from the macro-cell base station to the femto-cell base station is made, such that an interference problem does not occur. However, in the case in which a non-subscriber's user terminal enters the femto-cell base station, the non-subscriber's user terminal still communicates with the macro-cell base station to interfere in communication of a neighboring subscriber's user terminal, thereby deteriorating service quality.

Korean Patent Laid-Open Publication No. 2010-0099605, which relates to a method for reducing interference between a home-eNB and a macro-eNB using MAC scheduling and a mobile telecommunication system for the same, has introduced a technology of using the MAC scheduling in order to reduce the interference between the home-eNB and the macro-eNB that are operated in the same band.

In addition, Patent Laid-Open Publication No. 2010-0021076, which relates to an apparatus and a method for offset frame construction and transmission to reduce co-channel interference in a mobile communication system, has introduced a technology of using some of common channels operated in different bands in order to reduce interference between interference channels of a broadcasting channel and a control channel that are operated in the same band.

However, the radio resource allocation technologies according to the related art as described above do not specifically disclose and imply a technology of allocating radio resources in any one of a dedicated carrier mode, a partially shared carrier mode, and a shared carrier mode that are differently determined depending on interference indicators of base stations, but have introduced only a configuration of varying MAC scheduling or temporarily changing a band with respect to a plurality of base stations operated in the same band.

Therefore, a new radio resource allocation technology of enabling radio resource allocation minimizing an influence of a non-subscriber's user terminal by allocating radio resources in any one of a dedicated carrier mode, a partially shared carrier mode, and a shared carrier mode that are differently determined depending on interference indicators of base stations and preferentially allocating the radio resources to a base station sensitive to a delay and interference in the dedicated carrier mode in order to decrease interference between a plurality of base stations operated in the same band has been urgently demanded.

### SUMMARY OF THE INVENTION

Accordingly, the present invention has been made keeping in mind the above problems occurring in the conventional art, and an object of the present invention is to enable radio resource allocation alleviating interference between base stations in a femto-cell network by allocating radio resources in any one of a dedicated carrier mode, a partially shared carrier mode, and a shared carrier mode that are differently determined depending on interference indicators of the base stations in the femto-cell network.

Another object of the present invention is to enable radio resource allocation increasing utilization of radio resources in a femto-cell network by differently allocating the radio resources depending on available radio resource situations of base stations in the femto-cell network.

Yet another object of the present invention is to enable radio resource allocation minimizing an influence of a non-subscriber's user terminal by preferentially allocating the radio resources to a base station sensitive to a delay and interference among base stations in a femto-cell network in a dedicated carrier mode.

In accordance with an aspect of the present invention, there is provided a radio resource allocation apparatus using an interference indicator in a femto-cell network, including: an interference indicator obtaining unit obtaining any one or more of interference indicators including load information of a base station in the femto-cell network, a change amount of reference signal received power (RSRP) to reference signal received quality (RSRQ), and a channel quality indicator (CQI); a priority determining unit providing different weights to each of the interference indicators and determining an allocation priority of radio resources using the interference indicators to which the weights are provided; and a radio resource allocating unit allocating the radio resources to the base station in any one of a dedicated carrier mode, a partially shared carrier mode, and a shared carrier mode using the allocation priority.

The priority determining unit may provide a first weight to the load information, provide a second weight to the change amount of reference signal received power to reference signal received quality, and provide a third weight to the channel quality indicator, and the weights may be high in a sequence of the first weight, the second weight, and the third weight.

The priority determining unit may set an interference indicator to which the highest weight among the weights provided to the interference indicators is provided to a reference indicator, set an interference indicator to which a weight lower than the weight provided to the reference indicator is provided to a corrected indicator, determine a reference priority using the reference indicator, and correct the reference priority using the corrected indicator to determine the allocation priority.

The radio resource allocating unit may judge whether or not the allocation priority is a preset dedicated priority or more, and allocate the radio resources to the base station in the dedicated carrier mode in the case in which it is judged that the allocation priority is the dedicated priority or more.

The radio resource allocating unit may judge whether or not the allocation priority is less than a preset common priority in the case in which it is judged that the allocation priority is less than the dedicated priority, and allocate the radio resources to the base station in the shared carrier mode in the case in which it is judged that the allocation priority is less than the common priority.

The dedicated priority may be the common priority or more.

The interference indicator obtaining unit may confirm whether or not a base station connection interface is present in the base station, and obtain the load information in the case in which the base station connection interface is present in the base station.

The interference indicator obtaining unit may confirm whether a downlink receiver is present in the base station, and obtain the change amount of reference signal received power to reference signal received quality in the case in which the downlink receiver is present in the base station.

The interference indicator obtaining unit may further obtain any one or more of interference indicators including a signal to interference ratio (SIR) and a signal to interference plus noise ratio (SINR) in the case in which the downlink receiver is present in the base station.

The priority determining unit may provide a second ranking weight to the signal to interference ratio and the signal to interference plus noise ratio.

In accordance with another aspect of the present invention, there is provided a radio resource allocation method using an interference indicator in a femto-cell network, including: obtaining any one or more of interference indicators including load information of a base station in the femto-cell network, a change amount of reference signal received power (RSRP) to reference signal received quality (RSRQ), and a channel quality indicator (CQI); providing different weights to each of the interference indicators and determining an allocation priority of radio resources using the interference indicators to which the weights are provided; and allocating the radio resources to the base station in any one of a dedicated carrier mode, a partially shared carrier mode, and a shared carrier mode using the allocation priority.

At the determining of the allocation priority of the radio resources, a first weight may be provided to the load information, a second weight may be provided to the change amount of reference signal received power to reference signal received quality, and a third weight may be provided to the channel quality indicator, and the weights may be high in a sequence of the first weight, the second weight, and the third weight.

At the determining of the allocation priority of the radio resources, an interference indicator to which the highest weight among the weights provided to the interference indicators is provided may be set to a reference indicator, an interference indicator to which a weight lower than the weight provided to the reference indicator is provided may be set to a corrected indicator, a reference priority may be determined using the reference indicator, and the reference priority may be corrected using the corrected indicator to determine the allocation priority.

At the allocating of the radio resources to the base station, it may be judged whether or not the allocation priority is a preset dedicated priority or more, and the radio resources may be allocated to the base station in the dedicated carrier mode in the case in which it is judged that the allocation priority is the dedicated priority or more.

At the allocating of the radio resources to the base station, it may be judged whether or not the allocation priority is less than a preset common priority in the case in which it is judged that the allocation priority is less than the dedicated priority, and the radio resources may be allocated to the base station in the shared carrier mode in the case in which it is judged that the allocation priority is less than the common priority.

The dedicated priority may be the common priority or more.

At the obtaining of any one or more of the interference indicators, it may be confirmed whether or not a base station connection interface is present in the base station, and the load information may be obtained in the case in which the base station connection interface is present in the base station.

At the obtaining of any one or more of the interference indicators, it may be confirmed whether a downlink receiver is present in the base station, and the change amount of reference signal received power to reference signal received quality may be obtained in the case in which the downlink receiver is present in the base station.

At the obtaining of any one or more of the interference indicators, any one or more of interference indicators including a signal to interference ratio (SIR) and a signal to interference plus noise ratio (SINR) may be further obtained in the case in which the downlink receiver is present in the base station.

At the determining of the allocation priority of the radio resources, a second ranking weight may be provided to the signal to interference ratio and the signal to interference plus noise ratio.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a radio resource allocation apparatus using an interference indicator in a femto-cell network according to an exemplary embodiment of the present invention;

FIG. 2 is a flow chart showing a radio resource allocation method using an interference indicator in a femto-cell network according to an exemplary embodiment of the present invention;

FIG. 3 is a flow chart showing an example of step S210 of obtaining interference indicators shown in FIG. 2; and

FIG. 4 is a flow chart showing an example of step S230 of allocating radio resources to a base station shown in FIG. 2.

### DESCRIPTION OF THE PREFERRED EMBODIMENTS

The present invention will be described in detail with below reference to the accompanying drawings. In the present specification, an overlapped description and a detailed description for well-known functions and configurations that may obscure the gist of the present invention will be omitted. Exemplary embodiments of the present invention are provided in order to more completely explain the present invention to those skilled in the art. Therefore, throughout the accompanying drawings, shapes, sizes, and the like, of components may be exaggerated for clarity.

Hereinafter, exemplary embodiments of the present invention will be described in detail with reference to the accompanying drawings.

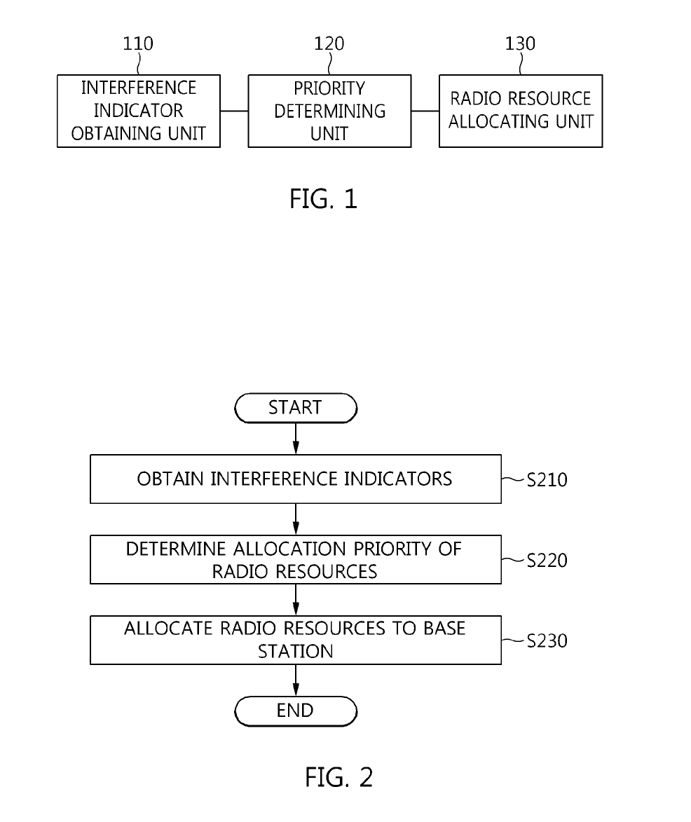

FIG. 1 is a block diagram showing a radio resource allocation apparatus using an interference indicator in a femto-cell network according to an exemplary embodiment of the present invention.

Referring to FIG. 1, the radio resource allocation apparatus using an interference indicator in a femto-cell network according to an exemplary embodiment of the present invention is configured to include an interference indicator obtaining unit 110, a priority determining unit 120, and a radio resource allocating unit 130.

The interference indicator obtaining unit 110 obtains any one or more of interference indicators such as load information of a base station in the femto-cell network, a change amount of reference signal received power (RSRP) to reference signal received quality (RSRQ), and a channel quality indicator (CQI).

Here, the reference signal received quality may be calculated based on the reference signal received power.

Here, the interference indicator obtaining unit 110 may further obtain an average value of the channel quality indicators and a deviation between the channel quality indicators in a sub-frame as the interference indicator.

Here, the interference indicator obtaining unit 110 may confirm whether or not a base station connection interface is present in the base station, and obtain the load information in the case in which the base station connection interface is present in the base station.

Here, the base station connection interface may be any one of an X2 interface and an S1 interface.

Here, the load information may be load information received from a base station neighboring to the base station.

Here, the interference indicator obtaining unit 110 may obtain an interference table including the load information in the case in which the base station connection interface is present in the base station.

Here, the interference table may include any one or more of the load information, a service ID, a base station identifier, a radio resource allocation mode, a neighboring cell density, a resource allocation state, the number of access terminals, available radio resources, an interference indicator, and an allocation priority.

Here, the interference indicator obtaining unit 110 may confirm whether a downlink receiver is present in the base station, and obtain the change amount of reference signal received power to reference signal received quality in the case in which the downlink receiver is present in the base station.

Here, the interference indicator obtaining unit 110 may further obtain any one or more of interference indicators such as a signal to interference ratio (SIR) and a signal to interference plus noise ratio (SINR) in the case in which the downlink receiver is present in the base station.

Here, the signal to interference ratio and the signal to interference plus noise ratio may be calculated using the reference signal received quality and the reference signal received power.

The priority determining unit 120 provides different weights to each of the interference indicators and determines an allocation priority of radio resources using the interference indicators to which the weights are provided.

Here, the priority determining unit 120 may provide a first weight to the load information, provide a second weight to the change amount of reference signal received power to reference signal received quality, and provide a third weight to the channel quality indicator.

Here, the priority determining unit 120 may provide a second ranking weight to the signal to interference ratio and the signal to interference plus noise ratio.

Here, the weights may be high in a sequence of the first weight, the second weight, and the third weight.

Here, the priority determining unit 120 may set an interference indicator to which the highest weight among the weights provided to the interference indicators is provided to a reference indicator, set an interference indicator to which a weight lower than the weight provided to the reference indicator is provided to a corrected indicator, determine a reference priority using the reference indicator, and correct the reference priority using the corrected indicator to determine the allocation priority.

The radio resource allocating unit 130 allocates the radio resources to the base station in any one of a dedicated carrier mode, a partially shared carrier mode, and a shared carrier mode using the allocation priority.

Here, the radio resource allocating unit 130 may judge whether or not the allocation priority is a preset dedicated priority or more, and allocate the radio resources to the base station in the dedicated carrier mode in the case in which it is judged that the allocation priority is the dedicated priority or more.

Here, the radio resource allocating unit 130 may judge whether or not the allocation priority is less than a preset common priority in the case in which it is judged that the allocation priority is less than the dedicated priority, and allocate the radio resources to the base station in the shared carrier mode in the case in which it is judged that the allocation priority is less than the common priority.

Here, the dedicated priority may be the common priority or more.

FIG. 2 is a flow chart showing a radio resource allocation method using an interference indicator in a femto-cell network according to an exemplary embodiment of the present invention.

Referring to FIG. 2, in the radio resource allocation method using an interference indicator in a femto-cell network according to an exemplary embodiment of the present invention, any one or more of interference indicators such as load information of a base station in the femto-cell network, a change amount of reference signal received power (RSRP) to reference signal received quality (RSRQ), and a channel quality indicator (CQI) is obtained (S210).

Here, the reference signal received quality may be calculated based on the reference signal received power.

Here, at step S210, an average value of the channel quality indicators and a deviation between the channel quality indicators in a sub-frame may be further obtained as the interference indicator.

Here, the interference indicator obtaining unit 110 may confirm whether or not a base station connection interface is present in the base station, and obtain the load information in the case in which the base station connection interface is present in the base station.

Here, the base station connection interface may be any one of an X2 interface and an S1 interface.

Here, the load information may be load information received from a base station neighboring to the base station.

Here, at step S210, an interference table including the load information may be obtained in the case in which the base station connection interface is present in the base station.

Here, the interference table may include any one or more of the load information, a service ID, a base station identifier, a radio resource allocation mode, a neighboring cell density, a resource allocation state, the number of access terminals, available radio resources, an interference indicator, and an allocation priority.

Here, at step S210, it may be confirmed whether a downlink receiver is present in the base station, and the change amount of reference signal received power to reference signal received quality may be obtained in the case in which the downlink receiver is present in the base station.

Here, at step S210, any one or more of interference indicators such as a signal to interference ratio (SIR) and a signal to interference plus noise ratio (SINR) may be further obtained in the case in which the downlink receiver is present in the base station.

Here, the signal to interference ratio and the signal to interference plus noise ratio may be calculated using the reference signal received quality and the reference signal received power.

Further, in the radio resource allocation method using an interference indicator in a femto-cell network according to an exemplary embodiment of the present invention, different weights are provided to each of the interference indicators, and an allocation priority of radio resources is determined using the interference indicators to which the weights are provided (S220).

Here, at step S220, a first weight may be provided to the load information, a second weight may be provided to the change amount of reference signal received power to reference signal received quality, and a third weight may be provided to the channel quality indicator.

Here, at step S220, a second ranking weight may be provided to the signal to interference ratio and the signal to interference plus noise ratio.

Here, the weights may be high in a sequence of the first weight, the second weight, and the third weight.

Here, at step S220, an interference indicator to which the highest weight among the weights provided to the interference indicators is provided may be set to a reference indicator, an interference indicator to which a weight lower than the weight provided to the reference indicator is provided may be set to a corrected indicator, a reference priority may be determined using the reference indicator, and the reference priority may be corrected using the corrected indicator to determine the allocation priority.

Further, in the radio resource allocation method using an interference indicator in a femto-cell network according to an exemplary embodiment of the present invention, radio resources are allocated to the base station in any one of a dedicated carrier mode, a partially shared carrier mode, and a shared carrier mode using the allocation priority (S230).

Here, at step S230, it may be judged whether or not the allocation priority is a preset dedicated priority or more, and the radio resources may be allocated to the base station in the dedicated carrier mode in the case in which it is judged that the allocation priority is the dedicated priority or more.

Here, at step 230, it may be judged whether or not the allocation priority is less than a preset common priority in the case in which it is judged that the allocation priority is less than the dedicated priority, and the radio resources may be allocated to the base station in the shared carrier mode in the case in which it is judged that the allocation priority is less than the common priority.

Here, the dedicated priority may be the common priority or more.

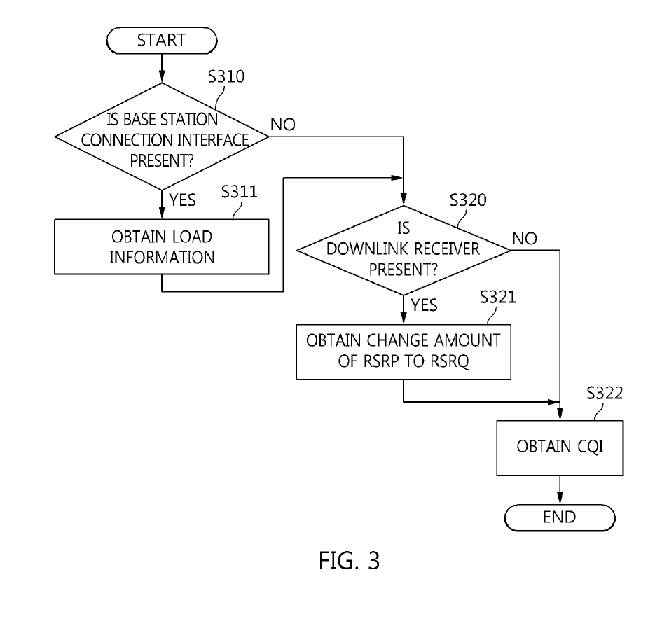

FIG. 3 is a flow chart showing an example of step S210 of obtaining interference indicators shown in FIG. 2.

Referring to FIG. 3, at step S210 of obtaining interference indicators shown in FIG. 2, it is confirmed whether or not a base station connection interface is present in a base station (S310).

In this case, at step S210 of obtaining interference indicators shown in FIG. 2, load information is obtained (S311) in the case in which the base station connection interface is present in the base station.

Here, the base station connection interface may be any one of an X2 interface and an S1 interface.

Here, the load information may be load information received from a base station neighboring to the base station.

Here, at step S311, an interference table including the load information may be obtained in the case in which the base station connection interface is present in the base station.

Here, the interference table may include any one or more of the load information, a service ID, a base station identifier, a radio resource allocation mode, a neighboring cell density, a resource allocation state, the number of access terminals, available radio resources, an interference indicator, and an allocation priority.

Here, at step S210 of obtaining interference indicators shown in FIG. 2, it is confirmed whether or not a downlink receive is present in the base station (S320).

Here, at step S210 of obtaining interference indicators shown in FIG. 2, a change amount of reference signal received power to reference signal received quality may be obtained (S321) in the case in which the downlink receiver is present in the base station.

Here, the reference signal received quality may be calculated based on the reference signal received power.

Here, at step S321, any one or more of interference indicators such as a signal to interference ratio (SIR) and a signal to interference plus noise ratio (SINR) may be further obtained in the case in which the downlink receiver is present in the base station.

Here, the signal to interference ratio and the signal to interference plus noise ratio may be calculated using the reference signal received quality and the reference signal received power.

Here, at step S210 of obtaining interference indicators shown in FIG. 2, a channel quality indicator (CQI) is obtained (S322).

Here, at step S322, an average value of the channel quality indicators and a deviation between the channel quality indicators in a sub-frame may be further obtained as the interference indicator.

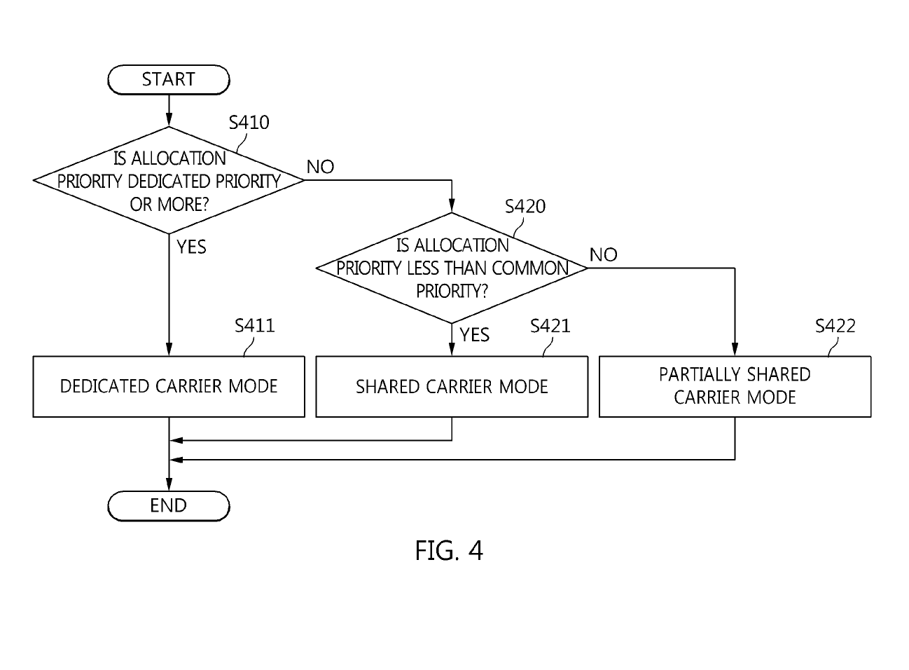

FIG. 4 is a flow chart showing an example of step S230 of allocating radio resources to a base station shown in FIG. 2.

Referring to FIG. 4, at step S230 of allocating radio resources to a base station shown in FIG. 2, it may be judged whether or not the allocation priority is a preset dedicated priority or more (S410).

Here, at step S230 of allocating radio resources to a base station shown in FIG. 2, the radio resources may be allocated to the base station in the dedicated carrier mode (S411) in the case in which it is judged that the allocation priority is the dedicated priority or more.

In addition, step S230 of allocating radio resources to a base station shown in FIG. 2, it may be judged whether or not the allocation priority is less than a preset common priority (S420) in the case in which it is judged that the allocation priority is less than the dedicated priority.

Here, the dedicated priority may be the common priority or more.

Here, at step S230 of allocating radio resources to a base station shown in FIG. 2, the radio resources may be allocated to the base station in the shared carrier mode (S421) in the case in which it is judged that the allocation priority is less than the common priority.

In addition, at step S230 of allocating radio resources to a base station shown in FIG. 2, the radio resources may be allocated to the base station in the partially shared carrier mode (S422) in the case in which it is judged that the allocation priority is not less than the dedicated priority.

In accordance with the present invention, radio resource allocation alleviating interference between base stations in a femto-cell network is enabled by allocating radio resources in any one of a dedicated carrier mode, a partially shared carrier mode, and a shared carrier mode that are differently determined depending on interference indicators of the base stations in the femto-cell network.

In addition, in accordance with the present invention, radio resource allocation increasing utilization of radio resources in a femto-cell network is enabled by differently allocating the radio resources depending on available radio resource situations of base stations in the femto-cell network.

Furthermore, in accordance with the present invention, radio resource allocation minimizing an influence of a non-subscriber's user terminal is enabled by preferentially allocating the radio resources to a base station sensitive to a delay and interference among base stations in a femto-cell network in a dedicated carrier mode.

In the radio resource allocation apparatus and method using an interference indicator in a femto-cell network according to an exemplary embodiment of the present invention as described above, the configuration and the method of the above-mentioned exemplary embodiment are not restrictively applied. That is, all or some of the respective exemplary embodiments may be selectively combined with each other so that they may be variously modified.

What is claimed is:

1. A radio resource allocation apparatus using an interference indicator in a femto-cell network, comprising:
an interference indicator obtaining unit obtaining any one or more of interference indicators including load information of a base station in the femto-cell network, a change amount of reference signal received power (RSRP) to reference signal received quality (RSRQ), and a channel quality indicator (CQI);
a priority determining unit providing different weights to each of the interference indicators and determining an allocation priority of radio resources using the interference indicators to which the weights are provided; and
a radio resource allocating unit allocating the radio resources to the base station in any one of a dedicated carrier mode, a partially shared carrier mode, and a shared carrier mode using the allocation priority.

2. The radio resource allocation apparatus using an interference indicator in a femto-cell network of claim 1, wherein the priority determining unit provides a first weight to the load information, provides a second weight to the change amount of reference signal received power to reference signal received quality, and provides a third weight to the channel quality indicator, and
the weights are high in a sequence of the first weight, the second weight, and the third weight.

3. The radio resource allocation apparatus using an interference indicator in a femto-cell network of claim 2, wherein the priority determining unit sets an interference indicator to which the highest weight among the weights provided to the interference indicators is provided to a reference indicator, sets an interference indicator to which a weight lower than the weight provided to the reference indicator is provided to a corrected indicator, determines a reference priority using the reference indicator, and corrects the reference priority using the corrected indicator to determine the allocation priority.

4. The radio resource allocation apparatus using an interference indicator in a femto-cell network of claim 3, wherein the radio resource allocating unit judges whether or not the allocation priority is a preset dedicated priority or more, and allocates the radio resources to the base station in the dedicated carrier mode in the case in which it is judged that the allocation priority is the dedicated priority or more.

5. The radio resource allocation apparatus using an interference indicator in a femto-cell network of claim 4, wherein the radio resource allocating unit judges whether or not the allocation priority is less than a preset common priority in the case in which it is judged that the allocation priority is less than the dedicated priority, and allocates the radio resources to the base station in the shared carrier mode in the case in which it is judged that the allocation priority is less than the common priority.

6. The radio resource allocation apparatus using an interference indicator in a femto-cell network of claim 5, wherein the dedicated priority is the common priority or more.

7. The radio resource allocation apparatus using an interference indicator in a femto-cell network of claim 3, wherein the interference indicator obtaining unit confirms whether or not a base station connection interface is present in the base station, and obtains the load information in the case in which the base station connection interface is present in the base station.

8. The radio resource allocation apparatus using an interference indicator in a femto-cell network of claim 7, wherein the interference indicator obtaining unit confirms whether a downlink receiver is present in the base station, and obtains the change amount of reference signal received power to reference signal received quality in the case in which the downlink receiver is present in the base station.

9. The radio resource allocation apparatus using an interference indicator in a femto-cell network of claim 8, wherein the interference indicator obtaining unit further obtains any one or more of interference indicators including a signal to interference ratio (SIR) and a signal to interference plus noise ratio (SINR) in the case in which the downlink receiver is present in the base station.

10. The radio resource allocation apparatus using an interference indicator in a femto-cell network of claim 9, wherein the priority determining unit provides a second ranking weight to the signal to interference ratio and the signal to interference plus noise ratio.

11. A radio resource allocation method using an interference indicator in a femto-cell network, comprising:
obtaining any one or more of interference indicators including load information of a base station in the femto-cell network, a change amount of reference signal received power (RSRP) to reference signal received quality (RSRQ), and a channel quality indicator (CQI);
providing different weights to each of the interference indicators and determining an allocation priority of radio resources using the interference indicators to which the weights are provided; and
allocating the radio resources to the base station in any one of a dedicated carrier mode, a partially shared carrier mode, and a shared carrier mode using the allocation priority.

12. The radio resource allocation method using an interference indicator in a femto-cell network of claim 11, wherein at the determining of the allocation priority of the radio resources, a first weight is provided to the load information, a second weight is provided to the change amount of reference signal received power to reference signal received quality, and a third weight is provided to the channel quality indicator, and
the weights are high in a sequence of the first weight, the second weight, and the third weight.

13. The radio resource allocation method using an interference indicator in a femto-cell network of claim 12, wherein at the determining of the allocation priority of the radio resources, an interference indicator to which the highest weight among the weights provided to the interference indicators is provided is set to a reference indicator, an interference indicator to which a weight lower than the weight provided to the reference indicator is provided is set to a corrected indicator, a reference priority is determined using the reference indicator, and the reference priority is corrected using the corrected indicator to determine the allocation priority.

14. The radio resource allocation method using an interference indicator in a femto-cell network of claim 13, wherein at the allocating of the radio resources to the base station, it is judged whether or not the allocation priority is a preset dedicated priority or more, and the radio resources are allocated to the base station in the dedicated carrier mode in the case in which it is judged that the allocation priority is the dedicated priority or more.

15. The radio resource allocation method using an interference indicator in a femto-cell network of claim 14, wherein at the allocating of the radio resources to the base station, it is judged whether or not the allocation priority is less than a preset common priority in the case in which it is judged that the allocation priority is less than the dedicated priority, and the radio resources are allocated to the base station in the shared carrier mode in the case in which it is judged that the allocation priority is less than the common priority.

16. The radio resource allocation method using an interference indicator in a femto-cell network of claim 15, wherein the dedicated priority is the common priority or more.

17. The radio resource allocation method using an interference indicator in a femto-cell network of claim 13, wherein at the obtaining of any one or more of the interference indicators, it is confirmed whether or not a base station connection interface is present in the base station, and the load information is obtained in the case in which the base station connection interface is present in the base station.

18. The radio resource allocation method using an interference indicator in a femto-cell network of claim 17, wherein at the obtaining of any one or more of the interference indicators, it is confirmed whether a downlink receiver is present in the base station, and the change amount of reference signal received power to reference signal received quality is obtained in the case in which the downlink receiver is present in the base station.

19. The radio resource allocation method using an interference indicator in a femto-cell network of claim 18, wherein at the obtaining of any one or more of the interference indicators, any one or more of interference indicators including a signal to interference ratio (SIR) and a signal to interference plus noise ratio (SINR) is further obtained in the case in which the downlink receiver is present in the base station.

20. The radio resource allocation method using an interference indicator in a femto-cell network of claim 19, wherein at the determining of the allocation priority of the radio resources, a second ranking weight is provided to the signal to interference ratio and the signal to interference plus noise ratio.
